(19) United States
(12) Patent Application Publication
(10) Pub. No.: US 2008/0191012 A1
(43) Pub. Date: Aug. 14, 2008

(54) Method for Tracking Food Product Using a Food Product Scale

(75) Inventors: Carla A. Monnier, Vandalia, OH (US); James E. Highley, Eaton, OH (US); Lawrence A. Pevoar, Miamisburg, OH (US); David S. Miller, Troy, OH (US); Santos Juan-Castellanos, Springfield, OH (US)

Correspondence Address: THOMPSON HINE LLP;Intellectual Property Group, P.O Box 8801, DAYTON, OH, 45401-8801, US

(73) Assignee: Premark FEG L.L.C., Wilmington, DE (US)

(21) Appl. No.: 12/025,942

(22) Filed: Feb. 5, 2008

Related U.S. Application Data
(60) Provisional application No. 60/888,846, filed on Feb. 8, 2007.

(51) Int. Cl. G06F 17/00

(52) U.S. Cl. 235/385

(57) ABSTRACT

A method of tracking food product status using a food product scale, the scale including a weighing station including an associated mechanism for producing weight indicative signals, and an operator interface screen including a display, is provided. The method includes entering product identification information of a food product into a food product scale using an operator interface of the food product scale. The food product scale identifies the food product based on the product information. A shelf life label is printed that includes shelf life information associated with the food product. A shelf life record is created that is saved in memory. The shelf life record includes the product identification information and an expiration date of the food product.

### CROSS-REFERENCE TO RELATED APPLICATIONS

This application claims priority to U.S. Provisional Patent Application No. 60/888,846, entitled “Method to Track Expired Product”, filed Feb. 8, 2007, the details of which are incorporated by reference.

### TECHNICAL FIELD

The present application relates generally to scales used to weigh food products in supermarkets, and more particularly to a system and method for tracking food product using a scale.

### BACKGROUND

Scales have been used in stores such as supermarkets and groceries to weigh and price food items and to generate a pricing label for such food items. A typical store includes multiple scales located in multiple perishables departments. It is important that weighed items be priced properly and therefore scales are commonly connected into a store network so that the latest pricing information can be provided to the scales in a timely manner. It may also be desirable to track expiration dates of food items and discards of food items.

### SUMMARY

In an aspect, a method of tracking food product status using a food product scale, the scale including a weighing station including an associated mechanism for producing weight indicative signals, and an operator interface screen including a display, is provided. The method includes entering product identification information of a food product into a food product scale using an operator interface of the food product scale. The food product scale identifies the food product based on the product information. A shelf life label is printed that includes shelf life information associated with the food product. A shelf life record is created that is saved in memory. The shelf life record includes the product identification information and an expiration date of the food product.

In another aspect, a method of tracking food product status using a food product scale, the scale including a weighing station including an associated mechanism for producing weight indicative signals, and an operator interface screen including a display, is provided. The method includes entering product identification information of a food product into a food product scale using an operator interface of the food product scale. The food product scale identifies the food product based on the product information. A discard food product is placed on the weighing station. The display displays a weight value of the discard food product. A type of discard is entered for the discard food product. A discard record is created for the discard food product that is saved in memory. The discard record includes the product identification information, the weight value and the type of discard.

Other advantages and features of the invention will be apparent from the following description of particular embodiments and from the claims.

### BRIEF DESCRIPTION OF THE DRAWINGS

FIG. 1 is a perspective view of an embodiment of a food product scale;

FIG. 2 is a schematic illustration of the food product scale of FIG. 1;

FIG. 3 is a schematic diagram of an embodiment of a store including multiple departments;

FIG. 4 is an embodiment of a user interface screen and display of the scale of FIG. 1;

FIG. 5 illustrates an embodiment of a shelf life label printed using the scale of FIG. 1;

FIG. 6 is an embodiment of flow chart for synchronizing scales;

FIG. 7 is an embodiment of a shelf life record list displayed by the scale of FIG. 1;

FIG. 8 is an embodiment of an operator instructions screen displayed by the scale of FIG. 1;

FIG. 9 is another embodiment of a user interface screen and display of the scale of FIG. 1;

FIG. 10 is another embodiment of a user interface screen and display of the scale of FIG. 1; and

FIG. 11 illustrates an embodiment of a discard label printed using the scale of FIG. 1.

### DETAILED DESCRIPTION

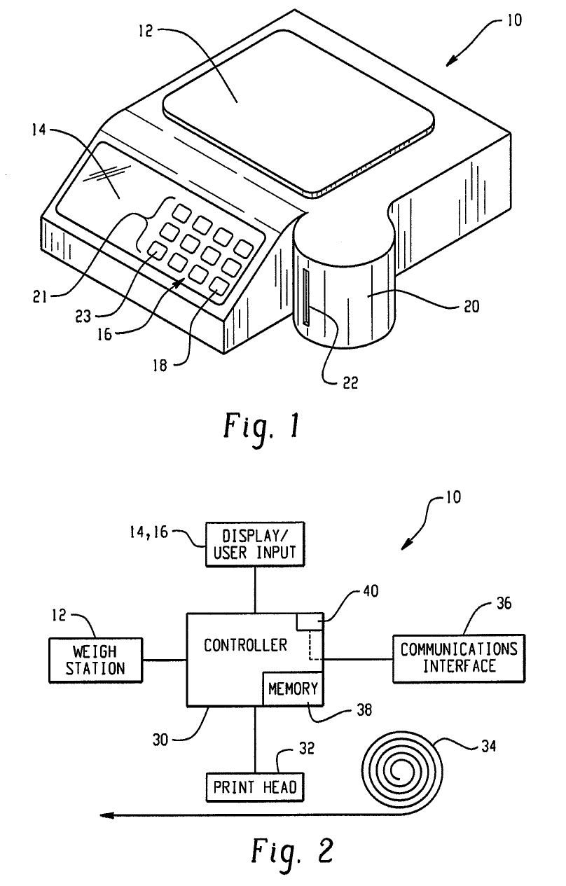

Referring to FIG. 1 an exemplary scale 10 is shown including a weigh station 12 and a display 14. Weigh station 12 may take the form of a platter-type member supported in relationship to a load cell (internal of the scale housing) that produces a weight indicative signal when a food item is placed on the weigh station 12 for weighing. Illustrated display 14 may take the form of an LCD-type display, but other technologies could be used. In the illustrated embodiment the display 14 is a touch screen-type display that also functions as a user input device 16 by displaying image buttons/icons 18 that can be triggered or selected by an operator. The buttons/icons 18 allow for user selection of an item to be weighed from a menu or group 21 of items 23 presented to the user by display 14. In one variation, the group 21 may be a numeric keypad allowing manual entry of product numbers. In another variation, the group 21 may be images of specific products that might be weighed by the scale. A separate operator input device could also be provided, for example, in the form of manually activated keys/buttons located alongside the display 14. A side portion 20 of the scale housing holds a label printer and associated supply of labels, which are dispensed through a label slot 22 in the housing. Although display screen 14 is shown incorporated into the housing of the scale 10, the display could take the form of a marquee-type display located on a support extending upward from the scale housing. In some implementations (e.g., a scale weigh and label system associated with a package wrapping machine for prepack), the display need not be attached to the scale/printer via a support but could be a separately housed console that is logically attached to the scale/printer.

Referring now to FIG. 2, an exemplary schematic of the scale 10 is shown. The scale includes a controller 30, such as a microprocessor based unit, connected to control the display 14 and user input 16 and connected to receive weight indicative signals from the weighing station 12. A print head 32 and associated supply of label stock 34 that can be moved past the print head 32 is also shown. In one example the print head 32 may be a thermal print head for use with thermally activated label stock. However, other types of printing technologies and label media could also be used. The controller 30 is also connected with a communications interface 36, which may take the form of a standard connector (and associated circuitry) for a USB, RS-232, Ethernet or other hard-wired communication line. In another example the communications interface 36 may be formed by a wireless communication device such as an RF transceiver. The communications interface 36 may communicate with other scales over the network. The network may also be connected to the Internet. The illustrated controller 30 includes associated memory 38 for storing product information (e.g., product names, characteristics and pricing stored in association with corresponding product numbers).

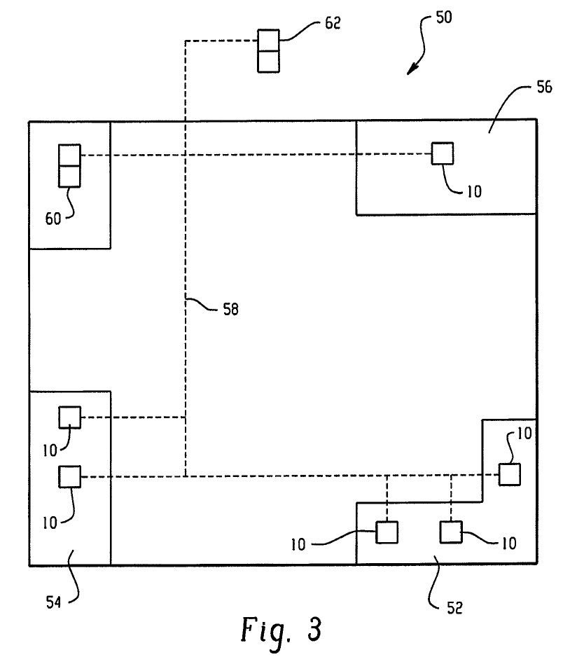

Referring also to FIG. 3, an exemplary store plan 50 is shown with multiple scales 10 in various store perishables departments 52, 54 and 56 (e.g., such as the deli department, the meat and fish department, the bakery department and/or the fruit and vegetable departments), each scale connected to a network 58 for communicating with one of the other scales 10 and/or for communicating a store computer, which may be located in the store as indicated by computer 60 or at a site remote from the store as indicated by computer 62. In a typical store application, each scale receives update data (e.g., price changes, etc.) via the network connection so that the scales are capable of labeling, pricing, tracking, etc. products accurately. The scales may receive the update data directly from a store computer 60 or 62, from one of the other scales or from a location remote from the store (e.g., from headquarters).

In one exemplary application, a cut-down item such as a block of cheese, loaf of turkey or ham is located in the deli department. Once the item is opened, it is desirable to track the expiration and/or any discards of the loaf of turkey or ham including any items derived from the loaf and placed on the shelf for purchase. The scales 10 are used to track the expiration date and discards of item as well as provide related information to the operator. As used herein, the term “expiration date” can also include an expiration time.

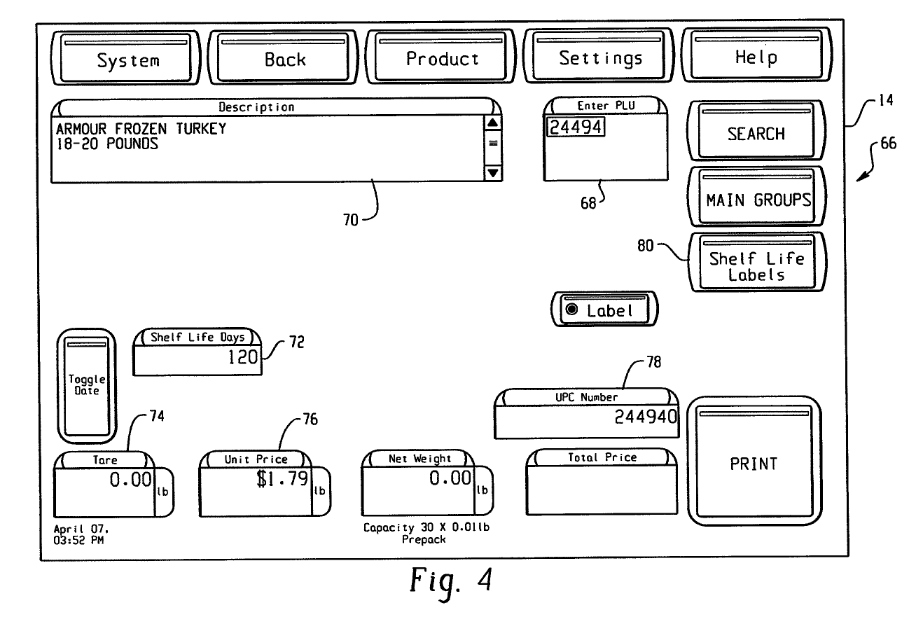

Referring now to FIG. 4, the displays 14 of the scales 10 include a user input screen 66. FIG. 4 is an exemplary user input screen and there may be other user input screens in addition to user input screen 66. The user input screen 66 includes an Enter PLU field 68 for use in entering a product look-up code (or other product identification information) and a Description field 70 for displaying a product description corresponding to the product look-up code. A Shelf Life Days field 72 displays a number of days that the product associated with the product identification information can be placed on the shelf for purchase. Other product information fields include a Tare field 74 for entering packaging weight, a Unit Price field 76 that displays a unit price associated with the product identification information and a UPC Number field 78 that displays the Universal Product Code for that product.

The number of days displayed in the Shelf Life Days field 72 can be a pre-set value retrieved from memory and associated with the PLU. The number of days displayed in the Shelf Life Days field 72 may also be selectable by the operator. Once the number of days displayed in the Shelf Life Days field 72 is acceptable to the operator, a Shelf Life Label button 80 is actuated and a shelf life label 82 is printed.

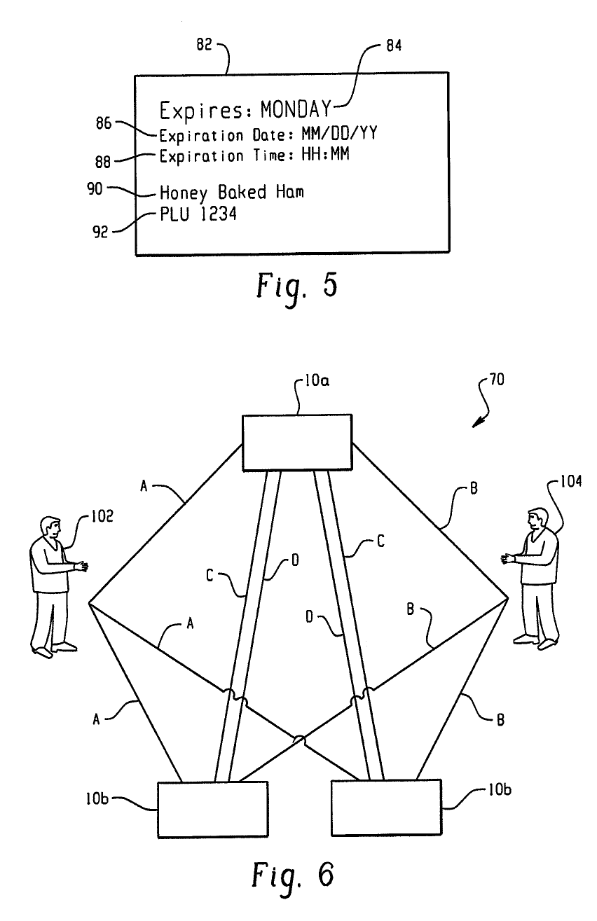

FIG. 5 illustrates an exemplary shelf life label 82. The shelf life label 82 includes an expiration day of the week 84, an expiration date 86, an expiration time 88, an item description 90 and PLU 92. When the shelf life label 82 is printed, a shelf life record is created in the scale 10 that will be used to track the item. The item may be tracked in any suitable increments, such as one hour increments.

Referring now to FIG. 6, an exemplary flow diagram 100 illustrates an approach for consolidating and distributing data, including the shelf life records. In the embodiment of FIG. 6, a primary scale 10a is responsible for consolidating and distributing update data pertaining to itself and one or more secondary scales 10b to another or other secondary scales 10b. Update data may be received from a number of sources. The self life records, a type of update data, are typically received by the primary scale 10a locally through an operator-initiated action at the primary scale or from a secondary scale where the shelf life label 82 is generated. Lines identified as A represent operator 102 interaction with a scale that causes changes to the scale's database. Lines identified as B represent updates from a location 104 remote from the scales, such as the store computer. Lines represented as C represent uploading of update data, such as self life records from the secondary scales 10b to the primary scale 10a. Lines represented as D represent the primary scale 10a synchronizing the secondary scales 10b with update data.

By default, a scale 10 may be configured as a primary scale or as a secondary scale. However, without a secondary scale 10b registered to a primary scale 10a, the primary scale may merely listen passively for update data and update its database when update data arrives. Similarly, a secondary scale 10b, without a primary scale 10a, may merely listen passively for update data and update its database when update data arrives. In some embodiments, an operator may change a scale from a primary scale to a secondary scale and vice versa using the user input device 16. In most embodiments, there is a single primary scale 10a for a group of secondary scales 10b. Typically, the secondary scale 10b maintains the primary scale's host name/IP address in order to communicate with the primary scale 10a over the network.

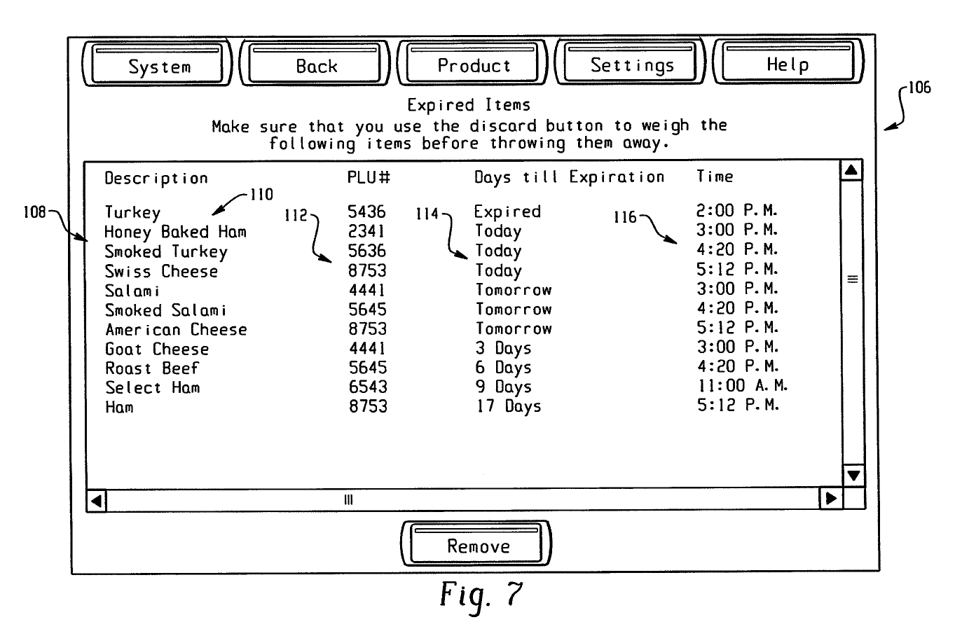

Referring to FIG. 7, all records for which a shelf life label 82 was created on the particular scale 10 will be displayed on an expiration screen 106 of that particular scale. All shelf life records are sent from the various secondary scales 10b to the associated primary scale 10a, where they all can be viewed. In some embodiments, each secondary scale 10b displays a list of shelf life records created at that secondary scale only. Thus, in these embodiments, only the primary scale 10a displays a list of shelf life records of all the scales, for example, of a department. In some embodiments, the primary scale 10a updates all the secondary scales 10b so that each secondary scale can display a list of shelf life records of all the scales.

The expiration screen 106 includes a list of individual shelf life records 108 with each record corresponding to an item for which a shelf life label 82 was created. Each shelf life record 108 includes a description 110 of the item, the PLU number 112, the days to expiration 114 and the time of expiration 116.

A visual indication may be provided to the operator that indicates a status of the particular item corresponding to the record. For example, expired items may be shown in red, items expiring within two days may be shown in blue and the other items shown in black. Additionally, if an item expires in zero or one day, the days to expiration 114 may say “Today” or “Tomorrow”.

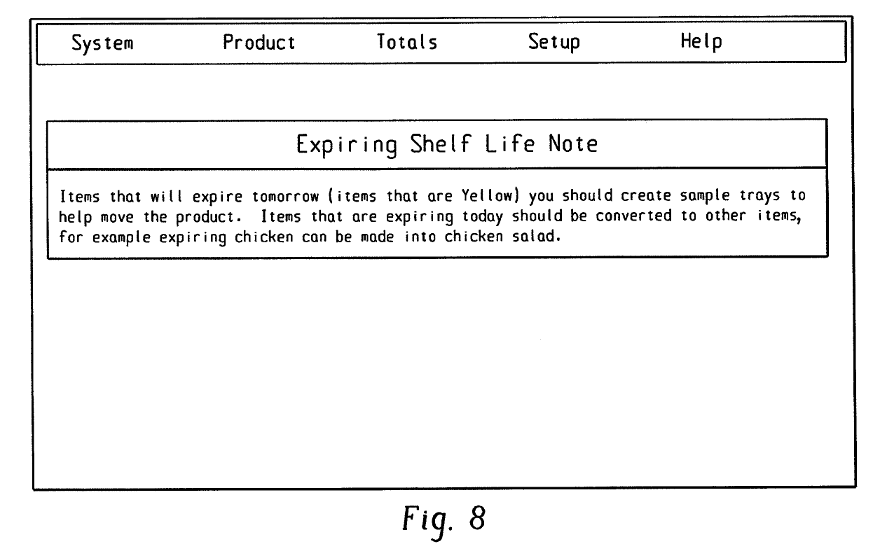

Referring to FIG. 8, the operator, such as a manager or supervisor, may associate instructions with records, which tell other operators what to do with expired or soon-to-be expired items. For example, the instructions may tell operators to prepare sample trays using soon-to-be expired items to help sell the soon-to-be expired items. Instructions may be associated with a particular shelf-life record or may apply to a group of shelf life records.

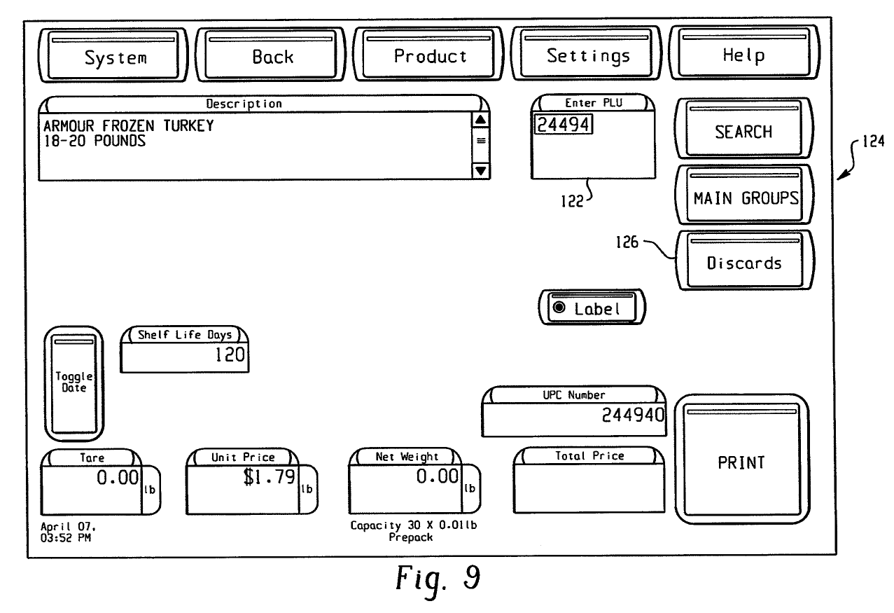

Referring to FIG. 9, the scales 10 may also be used to track item discards. A discard is any item or part of an item that cannot be sold. Discards may be classified as dropped or damaged items, expired shelf life, conversion (i.e., using the item to make a different item), over-production, samples and transfers (e.g., out of the department).

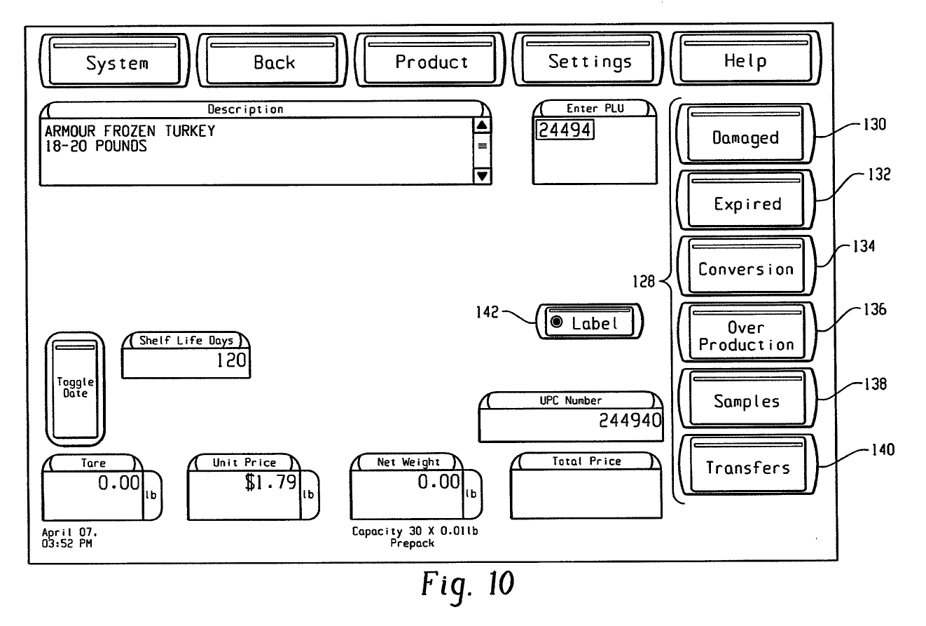

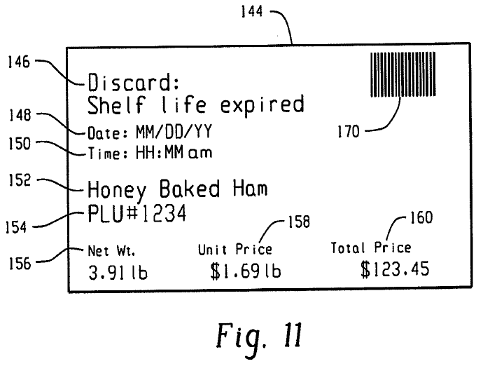

To create a discard record, the operator enters a PLU number corresponding to the item in the Enter PLU field 122 of screen 124. A Discards button 126 is selected, which displays a set 128 of pre-programmed buttons to handle different types of discards as shown by FIG. 10. The set 128 of pre-programmed buttons include a Damaged button 130, an Expired button 132, a Conversion button 134, an Over-production button 136, a Samples button 138 and a Transfers button 140. The operator places the discard item on the weight station 12 of the scale 10 and presses the button associated with the type of discard. Once the button is actuated indicating the type of discard, the scale 10 stores information as a discard record for the discarded product such as date, time, PLU number, net weight, total price, discard reason and operator ID.

In some instances, it may be desirable to generate a discard label by actuating a Label button 142. FIG. 11 illustrates an exemplary discard label 144. The discard label 144 includes the discard reason 146, date of discard 148, time of discard 150, description of item discarded 152, PLU number 154, net weight 156, unit price 158, total price 160 and a barcode 170.

All discard records created on the particular scale 10 will be displayed on a screen of that particular scale. All discard records are sent from the various secondary scales 10b to the associated primary scale 10a, where they all can be viewed. In some embodiments, each secondary scale 10b provides a list of discard records created at that secondary scale only. Thus, in these embodiments, only the primary scale 10a displays a list of shelf life records of all the scales, for example, of a department. In some embodiments, the primary scale 10a updates all the secondary scales 10b such that the list of discard records of all the scales can be viewed at the secondary scale. The scale 10 may also total discard data such as total price for each record over a selected period of time. The scales 10 may also be used to generate various reports, which may be printed by the scales. For example, a report may be generated displaying all discard totals including all discard type or of all discard totals by discard type.

It is to be clearly understood that the above description is intended by way of illustration and example only and is not intended to be taken by way of limitation. For example, instead of a scale, a printer having many of the features described above except for a weighing station may be connected to the network and be used in tracking food product. The printer may be used as a primary printer for collecting, displaying and printing shelf life and discard records from the scales. Other changes and modifications could be made.

What is claimed is:

1. A method of tracking food product status using a food product scale, the scale including a weighing station including an associated mechanism for producing weight indicative signals, and an operator interface screen including a display, the method comprising:
entering product identification information of a food product into a food product scale using an operator interface of the food product scale, the food product scale identifying the food product based on the product information;
printing a shelf life label that includes shelf life information associated with the food product;
creating a shelf life record that is saved in memory, the shelf life record including the product identification information and an expiration date of the food product.

2. The method of claim 1, wherein the food product scale is a secondary food product scale and the method includes sending the shelf life record to a primary food product scale for storage in memory of the primary food product scale.

3. The method of claim 1, wherein the shelf life record is stored in memory of the food product scale and the food product scale includes logic for tracking the upcoming expiration date of the food product, the secondary food product scale displaying expiration information on the display based on the expiration date.

4. The method of claim 3, wherein the food product scale includes a label printing mechanism and in the printing step, the shelf life label is printed by the label printing mechanism.

5. The method of claim 3 further comprising the secondary food product scale tracking the number of days until the expiration date and displaying the number of days until the expiration date on the display.

6. The method of claim 3 further comprising discarding the food product after its associated expiration date.

7. The method of claim 6 further comprising creating a discard record for the food product at the secondary food product scale and saving the discard record in memory of the secondary food product scale.

8. The method of claim 5 further comprising changing a color of the expiration information displayed on the display based on the number of days until the expiration date.

9. The method of claim 5 further comprising the first food product scale tracking the number of hours until the expiration date.

10. The method of claim 2, wherein the primary food product scale receives shelf life records from multiple secondary food product scales, the primary food product scale displaying the shelf life records received from the multiple secondary food product scales.

11. The method of claim 1 further comprising
generating operator instructions;
associating the operator instructions with one or more shelf life records of a shelf life record list; and
displaying the operator instructions.

12. A method of tracking food product status using a food product scale, the scale including a weighing station including an associated mechanism for producing weight indicative signals, and an operator interface screen including a display, the method comprising:
entering product identification information of a food product into a food product scale using an operator interface of the food product scale, the food product scale identifying the food product based on the product information;
placing a discard food product on the weighing station, the display displaying a weight value of the discard food product;
entering a type of discard for the discard food product; and
creating a discard record for the discard food product that is saved in memory, the discard record including the product identification information, the weight value and the type of discard.

13. The method of claim 12, wherein the food product scale displays multiple discard type options and the entering step involves selecting one of the displayed discard type options.

14. The method of claim 13, wherein the food product scale is a secondary food product scale and the method includes sending the discard record to a primary food product scale for storage in memory of the primary food product scale.

15. The method of claim 14 further comprising sending multiple discard records from multiple secondary food product scales to a the primary food product scale.

16. The method of claim 12, wherein the discard record is stored in memory of the food product scale.
